(19) United States
(12) Patent Application Publication
(10) Pub. No.: US 2006/0259955 A1
(43) Pub. Date: Nov. 16, 2006

(54) Attribute-based allocation of resources to security domains

(75) Inventors: Wolfgang Gunther, Munchen (DE); Erik Luft, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/429,173

(22) Filed: May 5, 2006

(30) Foreign Application Priority Data
May 11, 2005 (DE) 102005021854.7 DE

(51) Int. Cl. H04L 9/32

(52) U.S. Cl. 726/2

(57) ABSTRACT

The invention relates to a method for the optimized assignment of access rights to IT resources managed by means of a security management system and to a correspondingly adapted security management system. According to the invention a security domain is defined on the basis of at least one attribute of IT resources and a plurality of authorization profiles is provided for the security domain. User groups are assigned to the domain and linked to profiles provided for the domain. IT resources for which the security management is responsible are allocated to the domain in accordance with the attribute defining the security domain, as a result of which user groups assigned to the domain receive access rights to the IT resources allocated to the domain in accordance with the profiles linked to them. The invention permits the user groups to be issued with authorizations that are tailored to the requirements of the individual groups.

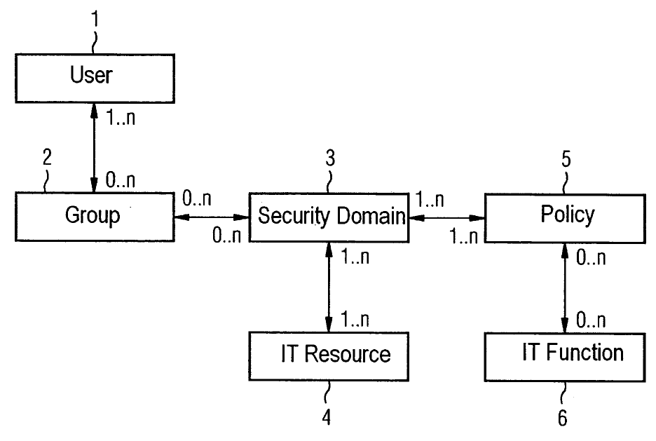

### CROSS REFERENCE TO RELATED APPLICATIONS

This application claims priority of German application No. 102005021854.7 DE filed May 11, 2005, which is incorporated by reference herein in its entirety.

### FIELD OF INVENTION

The invention relates to a method for the optimized assignment of access rights to IT resources managed by means of a security management system.

### BACKGROUND OF INVENTION

The aspect of security plays an increasingly significant role in systems in the IT (Information Technology) sector. In the digital age, only suitable security provisions can guarantee that the individual's private sphere remains protected and the generally accepted rules of behavior and conduct in dealing with people and devices are observed. Security aspects are therefore an important consideration in practically every system from the IT sector.

Accordingly, security management is also a central component in the management of networks (a term also often used in this context is TMN (Telecommunication Management Network)), ranking equally alongside other central functions such as fault management, configuration management, accounting management and performance management.

The security management of an IT system has the task of granting users of the system access rights (also often referred to in this context as authorizations) to IT resources of the system in the area of responsibility of the security management. Access rights of this kind can include read permission, write permission, permission to delete, and similar privileges. For the purpose of assigning rights the users are typically classified into groups, to each of which specific rights are allocated.

The customary procedure at the present time is described in more detail below with reference to the figure. The figure shows a schematic representation with six blocks which are linked with one another by means of assignments. In this arrangement users 1 (User) are assigned to groups 2 (Group). The groups are linked in turn to a third block 3 which represents security domains (Security Domain) and which is linked in turn to the blocks 4 (IT Resource) and 5 (Policy). Block 5 (Policy) is in turn connected to the sixth block (6: IT Function). In this scheme the three blocks vertically arranged in the middle 2 (Group), 3 (Security Domain) and 5 (Policy) each include elements which originate from another block. The user group 2 includes users, the security domain 3 IT resources and the policy 4 IT functions. A policy, referred to in the following as an authorization profile, usually combines a series of IT functions whose execution is permitted by this authorization profile. IT functions would include, for example, access actions such as reading, writing and deleting, but can also encompass application-related actions such as the sending of specific messages or the execution or starting of programs, for in general a group of users has linked to it not only authorizations of the operating system, but also authorizations at application level which are defined by means of links to security domains and authorization profiles.

A method referred to as containment is currently used in the specifications of access rights to an IT resource. In this case the process starts with the user who generates or creates the IT resource. In order to define the access rights, all groups to which the generating user belongs are determined first. Next, the security domains are identified which are linked to these groups and are related to authorization profiles which provide authorization to create and delete a resource. Finally, the new IT resource is allocated to the security domains determined in this way. With the aid of this method access to the IT resource is made possible not only for the generating user himself, but also for all users that are in a group relationship with said user.

### SUMMARY OF INVENTION

It is an object of the present invention to optimize the allocation of access rights to IT resources by a security management system.

The invention achieves this object by means of the method described in the claims. The invention is based on the knowledge that the attributes of the respective IT resource should be used as a key criterion for the allocation of usage rights in order to be able in this way to assign access rights in the most effective and optimized manner possible. Consequently, security domains are defined according to the invention on the basis of one or more attributes of IT resources. A plurality of authorization profiles can then be provided for a security domain. These authorization profiles can be designed according to the attribute or attributes of the security domain. For example, a user generates specifically for a security domain authorization profiles which have been tailored to the attribute or attributes of the IT resources within the domain. Alternatively it may be that pre-generated authorization profiles already exist, i.e. a pool of authorization profiles from which suitable profiles for the domain are used or, as the case may be, linked to it.

A further step of the method consists in assigning user groups to the domain, whereby this assignment may be direct or immediate, or else indirect. An indirect assignment would be, for example, an assignment via the authorization profile, the authorization profile in turn being linked to the domain. The user groups assigned to the domain are linked to the profiles provided for the domain. The allocation of IT resources to the domain is effected according to the invention on the basis of the attributes of IT resources or of the attribute of IT resources that the corresponding security domain defines. Finally, the users belonging to user groups which have been assigned to the domain receive access rights to IT resources allocated to the domain in accordance with the profiles linked to them.

The procedure according to the invention permits security domains to be formed in such a way that the access authorizations for different groups can be modeled according to the needs of the groups. Common (shared) resource pools can be modeled for users with widely differing authorization profiles. For example, modeling can be performed according to the following principle. All users of group X may create resources and process them collectively using an authorization profile Y, where Y must receive rights for creating and deleting resources. In addition users in group V may process the resources using authorization profile Z, where Z grants no rights for creating or deleting, i.e. no rights to the lifecycle of the resource. The sequence of the steps specified in the method according to the invention can be modified without problems by the person skilled in the art with regard to an optimization for his security management system. The method according to the invention is not restricted to the sequence in which the steps are listed; the possible alternatives for different method step sequences are immediately apparent. The sequence used in listing the steps is therefore also not to be understood as a restriction to a corresponding time sequence of the method steps.

An example of a system in which a method of the above kind can be used is a network management system. In this case an IT resource is provided, for example, in the form of a network element.

The method according to the invention can be described in the form of rules and programmed for automatic execution. Suitable tools for this purpose are available to the person skilled in the art; for example, an XML file could be provided which codes the corresponding method steps.

The present invention also includes a security management system (e.g. as an integrated part of a network management system) which has means for performing the method according to the invention. These means include, for example, software routines which perform the individual method steps automatically.

### BRIEF DESCRIPTION OF THE DRAWING

The subject matter of the invention is explained in more detail below within the context of an exemplary embodiment and with reference to a FIGURE.

### DETAILED DESCRIPTION OF INVENTION

The FIGURE represents the scheme already described more precisely in the introduction to the description in terms of the interdependencies of the individual elements that are relevant to the invention. In the context of the exemplary embodiment it is assumed that the security management system is part of a network management system. The IT resources are then network resources of all types, such as, for example, object instances as representations for network elements for switching connections. In this case the authorization profile would be the sum total of all operations which are to be permitted on said objects.

Attributes of network elements which can be used for defining security domains include, for example:
Transmission layer(s) or protocol(s) which support(s) the network element at its output ports. Examples: SDH/SONET, ATM, PDH-E1, DSL-ATM
The interworking type of the network element (protocol conversion/transformation)
   Examples: PDH-T3/IP for edge routers, ATM/V5.1 for coupling broadband access to narrowband switching centers.
The IP address space in which the network element comes to reside in the operator's Ethernet.
   Example of an IP address mask: 255.101.128.128
Signaling type of the network element
   Example: CCS#7 (Signaling System No. 7)
Remaining residual bandwidth
A naming scheme for the display name of the network element, by means of which the network operator can define connection/access areas without having to model these in the network management system.
   Example: “BonnSouth” as prefix
Topological criteria such as, for example, membership of specific subnetworks.

For the purposes of detailed illustration two attributes will be picked out in the following in order to describe the subject matter of the invention with the aid of a simple case scenario.

Assume there is a network planner A who is authorized to create and delete network elements of all types. A only has access to the network elements of the domain “Airport”, since his area of responsibility is restricted to the information infrastructure of an airport. Alarm monitor B is a specialist in SDH transmission technology (SDH: Synchronous Digital Hierarchy) and is exclusively responsible for network elements of this transmission type. All the network elements which have been created by the network planner A and which support SDH are to be made accessible to alarm monitor B, without B having creation or deletion rights.

According to the invention a security domain is defined by means of attributes of the network elements in order to be able to generate access rights tailored to these requirements. Two attributes of network elements are used here for defining the security domain. The first attribute is the location of the network element in the airport area. This attribute is referenced below as “Airport”. The second attribute is that the network element supports the SDH transmission layer. This attribute will be referred to in the following by “SDH”. A security domain (SDH, Airport) is now defined by means of the two network element attributes, support for the SDH transmission layer, and arrangement in the area of the airport. Network elements having these attributes are assigned to the security domain. In addition two user groups are provided which are designated as “Network Planner Airport” and “Alarm Monitor”. Network planner A and alarm monitor B are assigned to the corresponding user groups. If the number of users is correspondingly small, individual users can also fulfill the role of user groups. Corresponding user profiles are provided for the two user groups, i.e. a profile A, which grants the authorization to create and delete network elements of all types, and a user profile B, which grants no rights for creating or deleting network elements, but does grant rights for querying and checking the status or functional integrity of the network elements. The user groups “Network Planner Airport” and “Alarm Monitor” are assigned to the domain (SDH, Airport). If a new network element is now created in the area of the airport by network planner A, the authorization assignment is not based, as in the prior art, solely on the group membership of network planner A. Instead, this network element is assigned to the security domain (SDH, Airport). This causes the user groups “Network Planner Airport” and “Alarm Monitor” assigned to the domain to receive access rights in accordance with the profiles linked to them. The access rights are therefore tailored to the user groups. Thus, for example, the corresponding network planner group can delete the network element again, while the alarm monitor group can only exercise monitoring and checking functions.

These operations can be coded by means of computer instructions so that the corresponding steps or allocations are performed automatically. In this way the invention can also be applied without difficulty to real-world cases, which are usually considerably more complex.

1.-5. (canceled)

6. A method for allocating access rights to resources managed via a security management system, comprising:
providing an attribute of a resource;
defining a security domain defined by an attribute;
providing a plurality of authorization profiles for the security domain;
assigning a plurality of user groups to the domain;
linking the user groups assigned to the domain to the profiles provided for the domain;
assigning resources to the security domain in accordance with the resource attribute; and
receiving access rights by user groups assigned to the domain receive.

7. The method as claimed in claim 6,
providing a plurality of resources,
wherein a network management system comprises the security management system, and
wherein at least one of the resources is a network element.

8. The method as claimed in claim 7, wherein an allocation rule is incorporated in a software program.

9. The method as claimed in claim 7, wherein an allocation rule is stored in a file that is read and interpreted.

10. The method as claimed in claim 6,
wherein a network management system comprises the security management system, and
wherein the resource is a network element.

11. The method as claimed in claim 10, wherein an allocation rule is incorporated in a software program.

12. The method as claimed in claim 11, wherein the method is used within a security management system.

13. The method as claimed in claim 10, wherein an allocation rule is stored in a file that is read and interpreted.

14. The method as claimed in claim 13, wherein an allocation rule is stored in a file that is read and interpreted.

15. The method as claimed in claim 14, wherein method is in a security management system.
